(19) United States
(12) Patent Application Publication
(10) Pub. No.: US 2023/0127083 A1
(43) Pub. Date: Apr. 27, 2023

(54) OPTICAL LINK SYSTEM FOR HEAD MOUNTED DISPLAY AND METHOD OF CONTROLLING THE SAME

(71) Applicant: OPTICIS CO., LTD., Seongnam-si (KR)

(72) Inventor: Sang Min KIM, Yongin-si (KR)

(21) Appl. No.: 17/671,947

(22) Filed: Feb. 15, 2022

(30) Foreign Application Priority Data
Oct. 26, 2021 (KR) 10-2021-0144007

(51) Int. Cl. H04N 13/122; H04N 7/22; H04N 13/344; G06T 5/00

(52) U.S. Cl. CPC H04N 13/122; H04N 7/22; H04N 13/344; G06T 5/006

(57) ABSTRACT

An optical link system includes a field programmable gate array (FPGA), and the FPGA includes an inter-pupillary distance (IPD) application unit and a barrel distortion execution unit.

### CROSS-REFERENCE TO RELATED APPLICATION

This application is based on and claims priority under 35 U.S.C. § 119 to Korean Patent Application No. 10-2021-0144007, filed on Oct. 26, 2021, in the Korean Intellectual Property Office, the disclosure of which is incorporated by reference herein in its entirety.

### BACKGROUND

### 1. Field

One or more embodiments relate to an optical link system for a virtual reality head mounted display and a method of controlling the optical link system.

### 2. Description of the Related Art

An optical link is a point-to-point optical communication device constituted by an optical transmitter, an optical fiber cable, an optical receiver, and other devices, wherein the optical transmitter converts an electrical signal into light and transmits the light through the optical fiber cable, and the optical receiver converts the light into an electrical signal, thereby enabling long-distance transmission of images and data between an image source and a display.

The optical link may receive power directly from the image source and a display device or from a separate power supply, and may support Li-Fi wireless optical communication instead of using fiber optic cables.

Virtual reality (VR) head mounted displays (HMD) may be classified into a type configured to receive video or audio data from a personal computer (PC) by wire or wirelessly and display or playback the received video or audio data, and a type having a processor configured to generate and display video or audio data.

FIG. 1 is a view illustrating an inter-pupillary distance (IPD). Because humans perceive a three-dimensional distance and depth through the difference between images entering the left and right eyes, individual images have to be provided to the left and right eyes according to the IPD as shown in FIG. 1.

Although early VR HMDs expressed three-dimensional effects with expensive and sophisticated lenses, the sensation of immersion was poor because of a narrow field of view (FOV) like looking at a cellular phone with binoculars. Thus, in order to provide a widened FOV and improve the sensation of immersion, recent VR HMDs perform fish-eye rendering on images to be displayed on the left and right eyes and then correct the distortion of the images by using a convex lens.

FIG. 2 is a view illustrating an example in which an image distorted in the form of a barrel as a result of fish-eye rendering is corrected using a convex lens in an HMD. In a distortion correction method shown in FIG. 2, an image having a barrel distortion as a result of fish-eye rendering may be corrected by pincushion distortion caused by a convex lens of an HMD to remove the barrel distortion by the combination of the barrel distortion and the pincushion distortion, and thus a finally observed image may have no distortion. In this manner, the FOV or angle of view of images may be widened to improve the sensation of immersion in the images.

When the process of fish-eye rendering and transmitting individual images, to which an IPD is applied, is not performed in real time, the images may be processed using a PC in advance and may then be transmitted. However, when the process of fish-eye rendering and transmitting individual images, to which an IPD is applied, is performed in real time, image stuttering or lagging may occur because the computation load on the processor of a PC or an HMD significantly increases as the resolution of original images increases.

Until now, the data transmission rate of wireless transmission technology including Wifi, LTE, and 5G is not sufficient compared to the data transmission rate of wired transmission technology, and thus uncompressed high-resolution original images may not be transmitted with high frames per second (FPS) by wireless transmission technology. In addition, when images are encoded and transmitted, a larger amount of computation is required in an HMD to decode the images, and thus image stuttering or lagging may significantly increase.

These phenomena may cause a poor sensation of immersion in VR and inconvenience in real-time game environments or the like, and may, in severe cases, result in harmful effects to humans such as VR motion sickness. It is known that conditions of 2K (1920×1080)×2 (individual images for the left and right eyes)×120 fps or higher are required to view images without VR motion sickness as on existing high-definition LCD screens.

### SUMMARY

One or more embodiments include an optical link system provided for a head mounted display to enable viewing of high-definition virtual reality (VR) images without stuttering or lagging, and a method of controlling the optical link system.

However, the embodiments are merely examples, and the present disclosure is not limited thereto.

Additional aspects will be set forth in part in the description which follows and, in part, will be apparent from the description, or may be learned by practice of the presented embodiments of the disclosure.

According to one or more embodiments, an optical link system includes an optical link for a head mounted display (HMD), the optical link including a field programmable gate array (FPGA), wherein the FPGA includes: an inter-pupillary distance (IPD) application unit; and a barrel distortion execution unit.

The HMD may include an IPD control unit configured to control an IPD degree of the IPD application unit.

The IPD control unit may include at least one selected from the group consisting of a button unit, a switch unit, a dial unit, and an external input unit, and the IPD degree may be adjusted using at least one selected from the group consisting of the button unit, the switch unit, the dial unit, and the external input unit.

The IPD control unit may include at least one selected from the group consisting of a button unit, a switch unit, a dial unit, and an external input unit, and the IPD degree may be turned on/off using at least one selected from the group consisting of the button unit, the switch unit, the dial unit, and the external input unit.

The HMD may include a barrel distortion control unit configured to control a barrel distortion degree of the barrel distortion execution unit.

The barrel distortion control unit may include at least one selected from the group consisting of a button unit, a switch unit, a dial unit, and an external input unit, and the barrel distortion degree may be adjusted using at least one selected from the group consisting of the button unit, the switch unit, the dial unit, and the external input unit.

The barrel distortion control unit may include at least one selected from the group consisting of a button unit, a switch unit, a dial unit, and an external input unit, and the barrel distortion degree may be turned on/off using at least one selected from the group consisting of the button unit, the switch unit, the dial unit, and the external input unit.

The optical link system may further include a transmission unit configured to transmit, to an image source, six degrees of freedom data of the HMD and control data of at least one selected from the group consisting of a keyboard, a mouse, and a virtual reality (VR) controller connected to the HMD by wire or wirelessly.

The optical link system may further include a power supply unit configured to supply power to the optical link.

According to one or more embodiments, a method of controlling an optical link includes: determining whether an image may be input; determining whether an inter-pupillary distance (IPD) function may be on; determining whether a barrel distortion function may be on; and transmitting the image to a head mounted display (HMD).

The determining of whether the IPD function is on may include cutting the input image into an image for a left eye and an image for a right eye according to a preset value, when the IPD function is on.

The determining of whether the barrel distortion function is on may include performing a barrel distortion operation according to a preset value, when the barrel distortion function is on.

Other aspects, features, and advantages will become apparent and more readily appreciated from the accompanying drawings, claims, and detailed description.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an inter-pupillary distance (IPD);

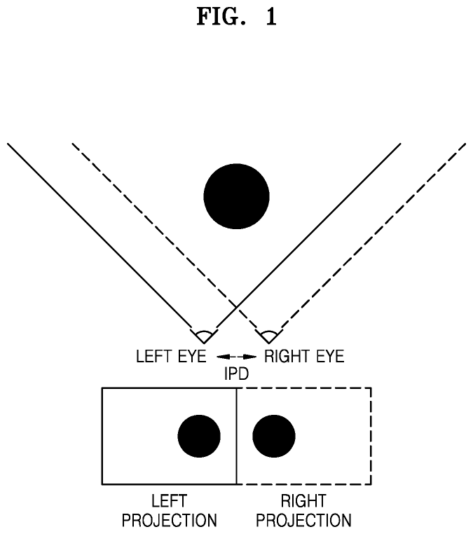

FIG. 2 is a view illustrating an example in which an image distorted in the form of a barrel as a result of fish-eye rendering is corrected using a convex lens in a head mounted display (HMD);

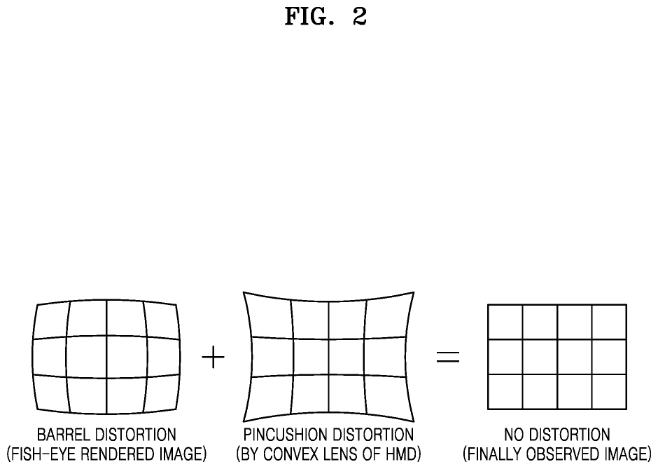

FIG. 3 is a block diagram illustrating an optical link system for an HMD according to an embodiment;

FIG. 4 is a block diagram illustrating an input unit configuration of an IPD control unit according to an embodiment;

FIG. 5 is a block diagram illustrating a configuration of a barrel distortion control unit according to an embodiment; and

FIG. 6 is a flowchart illustrating a method of controlling an optical link system for an HMD, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The present disclosure may have various different forms and various embodiments, and specific embodiments are described with reference to the accompanying drawings. However, the present disclosure is not limited to the specific embodiments, and it should be understood that the idea and technical scope of the embodiments cover all the modifications, equivalents, and replacements. In the descriptions of embodiments, like reference numerals denote like elements.

Hereinafter, embodiments will be described with reference to the accompanying drawings. In the drawings, like reference numerals denote like elements, and overlapping descriptions thereof will be omitted.

In the following descriptions of the embodiments, although terms such as “first” and “second” are used to describe various elements, these elements should not be limited by these terms. These terms are only used to distinguish one element from another element.

The terms of a singular form may include plural forms unless otherwise mentioned.

It will be further understood that the terms “comprises” and/or “comprising” used herein specify the presence of stated features or elements, but do not preclude the presence or addition of one or more other features or elements.

Sizes of elements in the drawings may be exaggerated for ease of explanation. In other words, sizes and thicknesses of elements in the drawings are arbitrarily illustrated for ease of explanation, and thus the following embodiments are not limited thereto.

In the following embodiments, the x-axis, the y-axis and the z-axis are not limited to three axes of the rectangular coordinate system, and may be interpreted in a broader sense. For example, the x-axis, the y-axis, and the z-axis may be perpendicular to one another, or may represent different directions that are not perpendicular to one another.

When a certain embodiment is implemented differently, a specific process order may be performed differently from the described order. For example, two consecutively described processes may be performed substantially at the same time or performed in an order opposite to the described order.

In the following description, the technical terms are used only for explaining a specific embodiment while not limiting the present disclosure. The term “include” or “comprise” used herein specifies the presence of a property, a fixed number, a step, a process, an element, a component, and a combination thereof, but does not exclude the presence or addition of other properties, fixed numbers, steps, processes, elements, components, and combinations thereof.

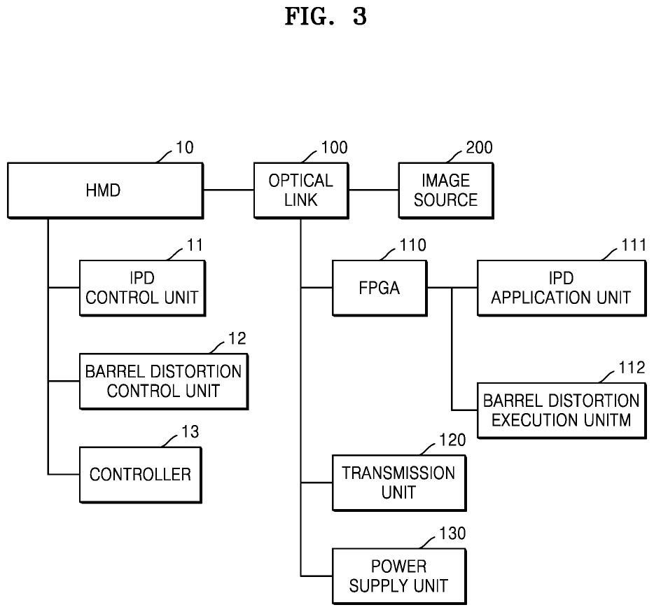

Hereinafter, an optical link system for a head mounted display (HMD) will be described according to embodiments with reference to FIGS. 3 to 5.

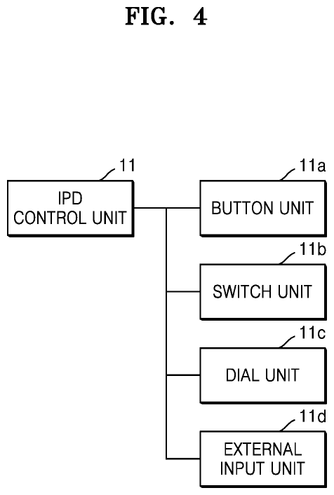

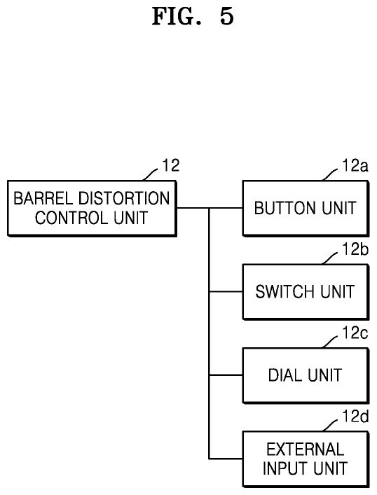

FIG. 3 is a block diagram illustrating an optical link system for an HMD according to an embodiment. FIG. 4 is a block diagram illustrating an input unit configuration of an IPD control unit 11 according to an embodiment. FIG. 5 is a block diagram illustrating a configuration of a barrel distortion control unit 12 according to an embodiment.

Referring to FIG. 3, according to an embodiment, the optical link system for an HMD includes a field programmable gate array (FPGA) 110, and the FPGA 110 includes an inter-pupillary distance (IPD) application unit 111 and a barrel distortion execution unit 112.

The FPGA 110 is a programmable non-memory semiconductor having a function changeable as needed. According to an embodiment, the FPGA 110 may be mounted on an optical link 100. The FPGA 110 may include the IPD application unit 111 and the barrel distortion execution unit 112. The FPGA 110 may apply an IPD to uncompressed original images in real time through the IPD application unit 111. In addition, the FPGA 110 may perform a barrel distortion operation on uncompressed original images in real time through the barrel distortion execution unit 112. The optical link 100 may transmit, to an HMD 10, images to which an IPD has been applied and on which a barrel distortion operation has been performed to fish-eye render the images.

In the optical link system of the embodiment, the optical link 100 performs an IPD application operation and a barrel distortion operation when a processor of a personal computer (PC) or a virtual reality (VR) device does not perform an IPD application operation and a barrel distortion operation, and the PC or the VR device are allowed to transmit non-encoded images owing to a sufficient transmission capacity of the optical link 100. Thus, a processor of the HMD 10 does not need to perform decoding such that even when the PC or the HMD 10 has a low-end processor, high-definition VR content may be provided in real time through the HMD 10. In addition, errors such as image stuttering or lagging may not occur even when the resolution or frame rate of images increases.

Referring to FIGS. 3 and 4, according to an embodiment, the HMD 10 may include the IPD control unit 11 configured to control an IPD degree of the IPD application unit 111.

Referring to FIG. 4, the IPD control unit 11 may include any one of a button unit 11a, a switch unit 11b, a dial unit 11c, and an external input unit 11d, and the IPD degree may be adjusted using at least one selected from the group consisting of the button unit 11a, the switch unit 11b, the dial unit 11c, and the external input unit 11d.

In addition, the IPD control unit 11 may turn on/off the IPD degree with at least one selected from the group consisting of the button unit 11a, the switch unit 11b, the dial unit 11c, and the external input unit 11d.

A user may adjust and turn on/off the IPD degree in real time according to the IPD of the user by using at least one selected from the group consisting of the button unit 11a, the switch unit 11b, the dial unit 11c, and the external input unit 11d provided on the HMD 10. IPD information controlled by the IPD control unit 11 may be transmitted to the IPD application unit 111 of the optical link 100. Then, the IPD application unit 111 of the optical link 100 may apply an IPD to images based on the IPD information transmitted to the optical link 100, and the barrel distortion execution unit 112 may fish-eye render the images and transmit the images to the HMD 10.

Referring to FIGS. 3 and 5, according to an embodiment, the HMD 10 may include the barrel distortion control unit 12 configured to control a barrel distortion degree of the barrel distortion execution unit 112.

Referring to FIG. 5, the barrel distortion control unit 12 may include any one of a button unit 12a, a switch unit 12b, a dial unit 12c, and an external input unit 12d, and the barrel distortion degree may be adjusted using at least one selected from the group consisting of the button unit 12a, the switch unit 12b, the dial unit 12c, and the external input unit 12d.

In addition, the barrel distortion control unit 12 may turn on/off the barrel distortion degree with at least one selected from the group consisting of the button unit 12a, the switch unit 12b, the dial unit 12c, and the external input unit 12d.

A user may adjust and turn on/off the barrel distortion degree in real time by using at least one selected from the group consisting of the button unit 12a, the switch unit 12b, the dial unit 12c, and the external input unit 12d provided on the HMD 10. Barrel distortion information controlled by the barrel distortion control unit 12 may be transmitted to the barrel distortion execution unit 112 of the optical link 100, and the barrel distortion execution unit 112 of the optical link 100 may apply barrel distortion to images in real time based on the barrel distortion information transmitted to the optical link 100.

According to an embodiment, the optical link 100 may further include a transmission unit 120 configured to transmit, to an image source 200, six degrees of freedom (DoF) data of the HMD 10 and control data of a controller 13 constituted by at least one selected from the group consisting of a keyboard, a mouse, and a VR controller connected by wire or wirelessly to the HMD 10. The image source 200 may include a PC or a VR device.

Six degrees of freedom data refers to data on rotation and movement with respect to x, y, and z axes. The HMD 10 may perceive six degrees of freedom in a three-dimensional space and may further include a transmission unit configured to communicate with the controller 13 to transmit data on the six degrees of freedom and control data of the controller 13 to the image source 200.

According to an embodiment, a power supply unit 130 may be further included to supply power to the optical link 100. Because the optical link 100 receives power through the power supply unit 130, the FPGA 110 of the optical link 100 may be operated regardless of whether the image source 200 or the HMD 10 has a power shortage.

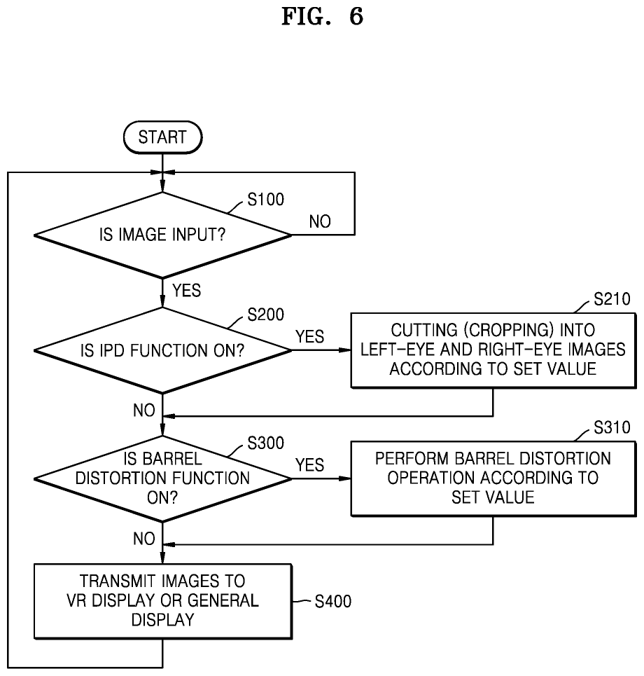

Hereinafter, a method of controlling an optical link system for an HMD will be described according to an embodiment with reference to FIG. 6.

FIG. 6 is a flowchart illustrating a method of controlling an optical link system for an HMD according to an embodiment.

Referring to FIG. 6, according to an embodiment, the method of controlling an optical link system for an HMD may include: determining whether an image is input (S100); determining whether an IPD function is on (S200); determining whether a barrel distortion function is on (S300); and transmitting the input image to an HMD (S400).

In this case, the operation S200 of determining whether the IPD function is on may include an operation S210 of cutting (cropping) the input image into an image for the left eye and an image for the right eye according to a preset value when it is determined that the IPD function is on.

In addition, the operation S300 of determining whether the barrel distortion function is on may include an operation S310 of performing a barrel distortion operation according to a preset value when it is determined that the barrel distortion function is on.

As described above, when an image is input to an optical link, and the IPD function and the barrel distortion function are on, the optical link may perform IPD control and barrel distortion control, and thus high-definition images may be viewed through the HMD without stuttering or lagging.

The present disclosure has been described with reference to the embodiments shown in the drawings, but the embodiments are merely examples. Those of ordinary skill in the art to which the present disclosure pertains will understand that various modifications may be made in the embodiments, and other equivalent embodiments are possible from the embodiments. Therefore, the scope of the present disclosure should be determined based on the appended claims.

Specific techniques described in the embodiments are merely examples and do not limit the technical scope of the embodiments. In order to concisely and clearly describe embodiments of the present disclosure, descriptions of general techniques and configurations of the related art may be omitted. Furthermore, line connections or connection members between elements depicted in the drawings represent functional connections and/or physical or circuit connections by way of example, and in actual applications, they may be replaced or embodied with various additional functional connections, physical connections, or circuit connections. In addition, elements described without using terms such as “essential” and “important” may not be necessary for constituting embodiments of the present disclosure.

An element referred to with the definite article or a demonstrative determiner may be construed as the element or the elements even though it has a singular form. Unless otherwise defined, the ranges defined herein are intended to include any embodiment to which values within the ranges are individually applied and may be considered to be the same as individual values constituting the ranges in the detailed description of the embodiments.

Operations of a method may be performed in an appropriate order unless explicitly described in terms of order or described to the contrary. Operations of a method are not limited to the stated order thereof.

In addition, examples or exemplary terms (for example, “such as” and “etc.”) are used for the purpose of description and are not intended to limit the scope of the present disclosure unless defined by the claims.

Also, those skilled in the art will readily appreciate that many alternations, combinations, and modifications may be made according to design conditions and factors within the scope of the appended claims and their equivalents.

As described above, according to the one or more of the above embodiments, the optical link system for an HMD is configured such that the FPGA of the optical link applies an IPD to uncompressed original images in real time and performs a barrel distortion operation on the images to produce fish-eye rendered images and transmit the fish-eye rendered images to an VR HMD, and thus a PC or HMD processor does not need to apply an IPD and perform a barrel distortion operation. Therefore, even low-end PC or HMD processors may provide, in real time, the same quality VR content as high-end PC or HMD processors without errors such as image stuttering or lagging even when the resolution or frame rate of images increases.

Effects of the present disclosure are not limited to the effects described above, and other effects not described above will be clearly understood by those skilled in the art from the claims.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. An optical link system comprising an optical link for a head mounted display (HMD),
wherein the optical link comprises a field programmable gate array (FPGA),
wherein the FPGA comprises:
an inter-pupillary distance (IPD) application unit; and
a barrel distortion execution unit,
wherein the HMD comprises:
an IPD control unit configured to control an IPD degree of the IPD application unit; and
a barrel distortion control unit configured to control a barrel distortion degree of the barrel distortion execution unit.

2. (canceled)

3. The optical link system of claim 1, wherein the IPD control unit comprises at least one selected from the group consisting of a button unit, a switch unit, a dial unit, and an external input unit, and the IPD degree is adjusted using at least one selected from the group consisting of the button unit, the switch unit, the dial unit, and the external input unit.

4. The optical link system of claim 1, wherein the IPD control unit comprises at least one selected from the group consisting of a button unit, a switch unit, a dial unit, and an external input unit, and the IPD degree is turned on/off using at least one selected from the group consisting of the button unit, the switch unit, the dial unit, and the external input unit.

5. (canceled)

6. The optical link system of claim 1, wherein the barrel distortion control unit comprises at least one selected from the group consisting of a button unit, a switch unit, a dial unit, and an external input unit, and the barrel distortion degree is adjusted using at least one selected from the group consisting of the button unit, the switch unit, the dial unit, and the external input unit.

7. The optical link system of claim 1, wherein the barrel distortion control unit comprises at least one selected from the group consisting of a button unit, a switch unit, a dial unit, and an external input unit, and the barrel distortion degree is turned on/off using at least one selected from the group consisting of the button unit, the switch unit, the dial unit, and the external input unit.

8. The optical link system of claim 1, further comprising a transmission unit configured to transmit, to an image source, six degrees of freedom data of the HMD and control data of at least one selected from the group consisting of a keyboard, a mouse, and a virtual reality (VR) controller connected to the HMD by wire or wirelessly.

9. The optical link system of claim 1, further comprising a power supply unit configured to supply power to the optical link.

10. A method of controlling an optical link, the method comprising:
determining whether an image is input in the optical link;
determining whether an inter-pupillary distance (IPD) function provided on the optical link is turned on;
determining whether a barrel distortion function provided on the optical link is turned on; and
transmitting the image to which the optical link applies an IPD to uncompressed original images in real time and performs a barrel distortion operation on the images to produce fish-eye rendered images to a head mounted display (HMD),
wherein the HMD comprises at least one selected from a group consisting of a button unit, a switch unit, a dial unit, and an external input unit,
wherein determining whether the inter-pupillary distance (IPD) function provided on the optical link is turned on comprises adjusting the IPD degree using at least one selected from the group consisting of the button unit, the switch unit, the dial unit, and the external input unit,
wherein determining whether the barrel distortion function provided on the optical link is turned on comprises adjusting the barrel distortion degree using at least one selected from the group consisting of the button unit, the switch unit, the dial unit, and the external input unit.

11. The method of claim 10, wherein the determining of whether the IPD function is on comprises cutting the input image into an image for a left eye and an image for a right eye according to a preset value, when the IPD function is on.

12. The method of claim 10, wherein the determining of whether the barrel distortion function is on comprises performing a barrel distortion operation according to a preset value, when the barrel distortion function is on.
